(19) United States
(12) Patent Application Publication
(10) Pub. No.: US 2012/0051426 A1
(43) Pub. Date: Mar. 1, 2012

(54) CODE AMOUNT REDUCING APPARATUS, ENCODER AND DECODER

(76) Inventors: Koichi Takagi, Saitama (JP); Sei Naito, Saitama (JP); Osamu Sugimoto, Saitama (JP)

(21) Appl. No.: 13/212,512

(22) Filed: Aug. 18, 2011

(30) Foreign Application Priority Data
Aug. 30, 2010 (JP) 2010-192719

(51) Int. Cl. H04N 7/32; H04N 7/64

(52) U.S. Cl. 375/240.12; 375/E07.243; 375/E07.279

(57) ABSTRACT

A sharp/blurred frame mode classifying unit specifies a frame to be subjected to sharp or blurred process. A 3D video signal extracting unit extracts a predetermined area or predetermined macro block in the specified target frame, and a 3D FFT 15 frequency-converts it to acquire a coefficient string. An intersection coordinate calculating unit finds a non-perceptible high frequency coefficient based on a spatio-temporal visual property model for the coefficient string, and a coefficient cut processing unit cuts the non-perceptible high frequency coefficient for a frequency conversion coefficient of orthogonal conversion of a predictive error signal. The code amount of a video signal is largely reduced for a high frame rate video by the processings only at the encode side without deteriorating the picture quality.

The present application is claims priority of Japanese Patent Application Serial No. 2010-192719, filed Aug. 30, 2010, the content of which is hereby incorporated by reference in its entirety.

### BACKGROUND OF THE INVENTION

1. Field of the Invention

The present invention relates to a code amount reducing apparatus, an encoder and a decoder in an apparatus for encoding video signals having a high frame rate particularly based on human visual property in order to perform encode control on the video signals.

2. Description of the Related Art

As an encode system based on human spatio-temporal visual property, there is proposed a system in Patent Literature 1 described later. In the Patent Literature 1, there is disclosed a technique in which an encode parameter is decided by a cost function minimizing rule using an encode distortion weighted based on a spatio-temporal visual property.

On the other hand, in Patent Literature 2 and Non-Patent Literature 1, there is disclosed an encoded picture controlling system using an illusion principle by sharp/blurred repeated playback. The sharp/blurred repeated illusion means that when there are pictures at 60 frames per second, for example, if sharp pictures (high resolution pictures, 30 frames per second) and blurred pictures (low resolution pictures, 30 frames per second) are repeated every picture, the entire picture seems fairly sharp. Consequently, it is expected to improve a picture encode efficiency with a little deterioration of the picture quality.
Patent Literature 1: Japanese Patent Application Laid-Open No. 2008-283599 Publication
Patent Literature 2: Japanese Patent Application Laid-Open No. 2009-100433 Publication
Non-Patent Literature 1: “Repetition of Sharp/Blurred TV Pictures and Its Application to Frame Interpolation (TFI)-Extension of Signal Processing of Visual Perception” Journal of The Institute of Image Information and Television Engineers 63(4) (727) pp. 549-552

However, the technique described in Patent Literature 1 has a problem that the code amount cannot be drastically reduced at a high frame rate such as 60 frames per second.

As described in Patent Literature 2 and Non-Patent Literature 1, since encoding low resolution pictures every picture may lead to lowering a correlation in the temporal direction, in some cases, the encode efficiency can be lowered. The system described in Patent Literature 2 and Non-Patent Literature 1 assumes that frames are uniquely decided as either sharp or blurred frames and a uniform filter processing is applied to the blurred frames in a picture. There is known that a problem occurs in which when the uniform filter processing is performed in the picture in this way, a deterioration partially occurs due to video motion property.

### SUMMARY OF THE INVENTION

It is an object of the present invention to provide a code amount reducing apparatus, an encoder and a decoder capable of highly reducing the code amount of a video signal for a high frame rate video without deteriorating the picture quality by processings only at the encode side.

In order to achieve the object, this invention is firstly characterized in that a code amount reducing apparatus in an apparatus for performing frequency conversion such as orthogonal conversion on a predictive error signal obtained by using a correlation between video signals in the temporal or spatial direction, and then encoding said predictive error signal, comprises a target frame specifying unit for specifying a frame to be processed, a unit for acquiring a coefficient string by collectively frequency-converting, for a target frame specified in said target frame specifying unit, pixel values at predetermined area or predetermined macro block of said target frame and pixel values at the same area or macro block in the frames before and after said target frame, a unit for finding a non-perceptible coefficient based on a spatio-temporal visual property model for said coefficient string and a unit for setting said non-perceptible high frequency coefficient at 0 for a frequency conversion coefficient of orthogonal conversion of said predictive error signal.

The invention is secondly characterized in that when said encode is in the intra-mode, said non-perceptible high frequency coefficient is set at 0 for said frequency conversion coefficient of orthogonal conversion of said predictive error signal, and when said encode is in the inter-mode, all said frequency conversion coefficients of orthogonal conversion of said predictive error signal are set at 0.

The invention is thirdly characterized in that the apparatus further comprises an encode mode selecting unit, wherein said encode mode selecting unit selects an encode mode having a smaller code amount from among the intra-mode in which said non-perceptible high frequency coefficient is set at 0 for said frequency conversion coefficient of orthogonal conversion of said predictive error signal and the inter-mode in which all said frequency conversion coefficients of orthogonal conversion of said predictive error signal are set at 0.

The invention is fourthly characterized in that an encoder for performing frequency conversion such as orthogonal conversion on a predictive error signal obtained by using a correlation between video signals in the temporal or spatial direction, and then encoding said predictive error signal, comprises a decoder for decoding an encoded video signal, a target frame specifying unit for specifying a frame to be processed, a unit for acquiring a coefficient string by collectively frequency-converting, for a target frame decoded in said decoding unit and specified in said target frame specifying unit, pixel values at predetermined area or predetermined macro block of said target frame and pixel values at the same area or macro block in the frames before and after said target frame, a unit for finding a non-perceptible coefficient based on a spatio-temporal visual property model for said coefficient string, a unit for setting said non-perceptible high frequency coefficient at 0 for a frequency conversion coefficient of orthogonal conversion of said predictive error signal, and a unit for reconstructing encoded data of said encoded video signal based on the result that said non-perceptible high frequency coefficient is set at 0.

The invention is fifthly characterized in that an encoder including the code amount reducing apparatus comprises a unit for encoding encode control processing information and applied frame number information acquired from said target frame specifying unit, wherein said encode control processing information and said applied frame number information encoded by said encoding unit are inserted into a bit stream containing said frequency conversion coefficient whose code amount is reduced by said code amount reducing apparatus, and are output.

The invention is sixthly characterized in that a decoder for decoding a video signal encoded by the encoder comprises a unit for separating a frequency conversion coefficient of a video signal, said encode control processing information and said applied frame number information from said bit stream, a unit for decoding said separated frequency conversion coefficient, a displaying unit for displaying a video signal acquired by said decoding, a unit for decoding said separated encode control processing information and applied frame number information, and a playback control unit for outputting a playback control signal, wherein when a control signal for slow motion playback or pause is output from said playback control unit, a processed frame specified by said target frame specifying unit from a video signal acquired by said decoding is skipped, and is not displayed on the displaying unit.

According to the first to sixth features, it is possible to provide a code amount reducing apparatus or an encoder suitable to be applied to an apparatus for encoding a video signal particularly at a high frame rate (such as 60 fps, 120 fps). The code amounts of the video signals per several frames can be largely reduced without deteriorating the picture quality by the processings only at the encode side.

According to the first feature, since the non-perceptible high frequency coefficient can be assumed as 0 based on the spatio-temporal visual property model for the frequency conversion coefficient of the orthogonal conversion of the predictive error signal, the code amount can be reduced with no or little deterioration of the substantial picture quality substantially.

According to the second feature, since all the frequency conversion coefficients of the orthogonal conversion of the predictive error signal are assumed as 0 in the inter-mode encode, a processing load is small and the code amount can be reduced with no or little deterioration of the substantial picture quality substantially.

According to the third feature, the encode mode having the smallest code amount can be selected with no or little deterioration of the substantial picture quality substantially.

Further, according to the fourth feature, the encode data can be reconstructed by the processing of assuming the high frequency coefficient which cannot be perceived based on the spatia-temporal visual property mode as 0, thereby the code amount of the encoded video signal is effectively reduced.

According to the fifth feature, the encode control processing information and the applied frame number information can be output to the decoder with ease and with no credibility damaged.

Further, according to the sixth feature, there can be configured such that deteriorated images are not displayed during slow motion playback or pause.

### BRIEF DESCRIPTION OF THE DRAWINGS

FIG. 1 is a block diagram showing a schematic structure of one embodiment of the present invention;

FIG. 2 is an explanatory diagram of a 3D video signal;

FIG. 3 is an explanatory diagram showing a relationship between a spatio-temporal visual property model and encode control;

FIG. 4 is an explanatory diagram of a spatial visual property model;

FIG. 5 is an explanatory diagram of one specific example of the encode control;

FIG. 6 is a block diagram showing a structure of essential parts according to a third embodiment of the present invention;

FIG. 7 is a block diagram showing a structure of essential parts according to a fourth embodiment of the present invention;

FIG. 8 is a conceptual diagram showing an exemplary sequence format output from an encoder according to the present invention;

FIGS. 9A to 9C are explanatory diagrams showing positions in a header where encode control processing information and applied frame number information are inserted; and

FIG. 10 is a schematic block diagram of a decoder suitable for decoding a signal encoded by the encoder according to the present invention.

### DETAILED DESCRIPTION OF THE PREFERRED EMBODIMENTS

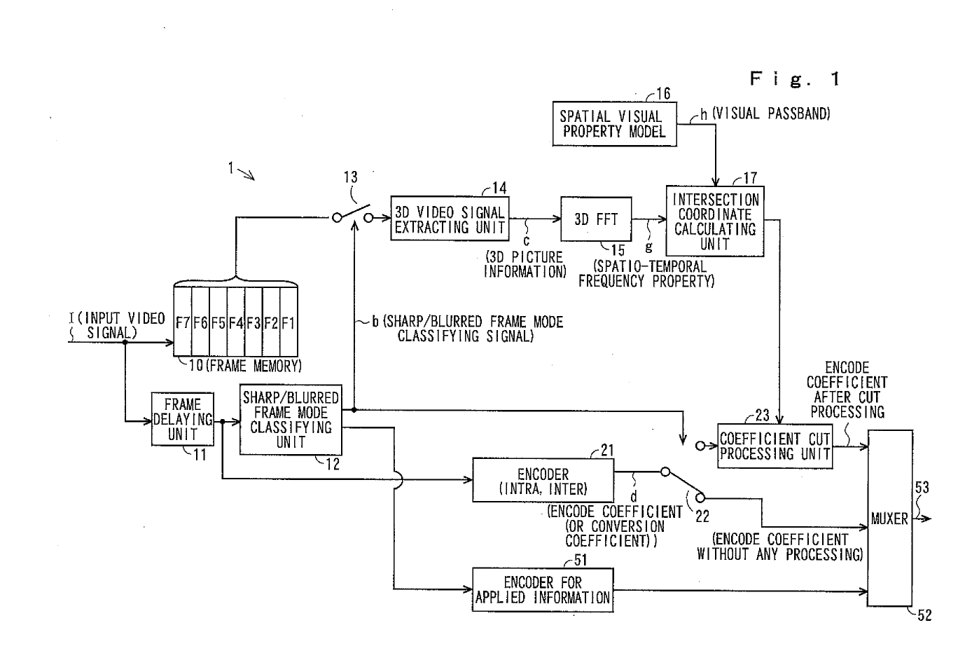

The present invention will be described below in detail with reference to the drawings. FIG. 1 is a block diagram for explaining one embodiment of the present invention. An explanation will be made below by way of a H.264 encoder, but the present invention is not limited thereto and is applicable to encoders using other methods.

In FIG. 1, it is assumed that an input video signal (I) is input to be encoded in units of frames into a code amount reducing apparatus 1. The input video signal (I) is managed in an appropriate signal form, and frame numbers and/or pixel positions can be appropriately acquired at any stage in the system.

The input video signal (I) is first stored in a frame memory 10 in order of frame number such as F1, F2, . . . , F7. This is because information on frames before and after the frame to be encoded needs to be referred to in the later processings. Though a capacity of the frame memory 10 depends on the number of frames to be referred to in a 3D FFT (Fast Fourier Transform) 15 in the later stage, the memory 10 can store information for more than the number of frames to be referred to.

A frame delaying unit 11 delays the input video signal (I) for a time for storing the information required for the processing of the 3D FFT 15 in the frame memory 10. For example, when the frame to be encoded is F4, the signal (I) is delayed for the time for storing the future frames F5 to F7.

A sharp/blurred frame mode classifying unit 12 as target frame specifying means for specifying a frame to be processed classifies the frame F4 to be encoded into either of sharp picture or blurred picture. It is preferable that an insertion ratio of the blurred frames into the sharp frames is such that the sharp frames and the blurred frames are repeated every frame for sharp/blurred playback, that is, at the ratio of 1:1, but the present invention is not limited thereto and may take an arbitrary ratio. The ratio of one blurred frame to two sharp frames or the ratio of one blurred frame to three sharp frames may be taken. Alternatively, the ratio may be decided according to the frame rate of the video signal. Actually, since as the frame rate is higher, the ratio of the number of blurred frames to the number of sharp frames can be increased more, there may be performed a processing of assuming 60 fps as one frame interval and, at a higher frame rate, increasing the ratio in proportion to the frame rate. The classification of sharp frame and blurred frame is made based on the frame numbers F. The sharp/blurred frame mode classifying unit 12 outputs a signal b (or binary signal 1) when the frame is classified as blurred and outputs nothing (or binary signal 0) when the frame is classified as sharp.

The sharp/blurred frame mode classifying unit 12 may also decide an interval between target frames according to a frame rate of the input signal.

When the frame is classified as blurred in the sharp/blurred frame mode classifying unit 12, a switching unit 13 is powered on (closed) and the processings described later will be performed. On the other hand, when the frame is classified as sharp, the switching unit 13 remains off (opened). As a determination whether sharp/blurred playback is performed is done by an encode block, the subsequent processings will be performed in units of block.

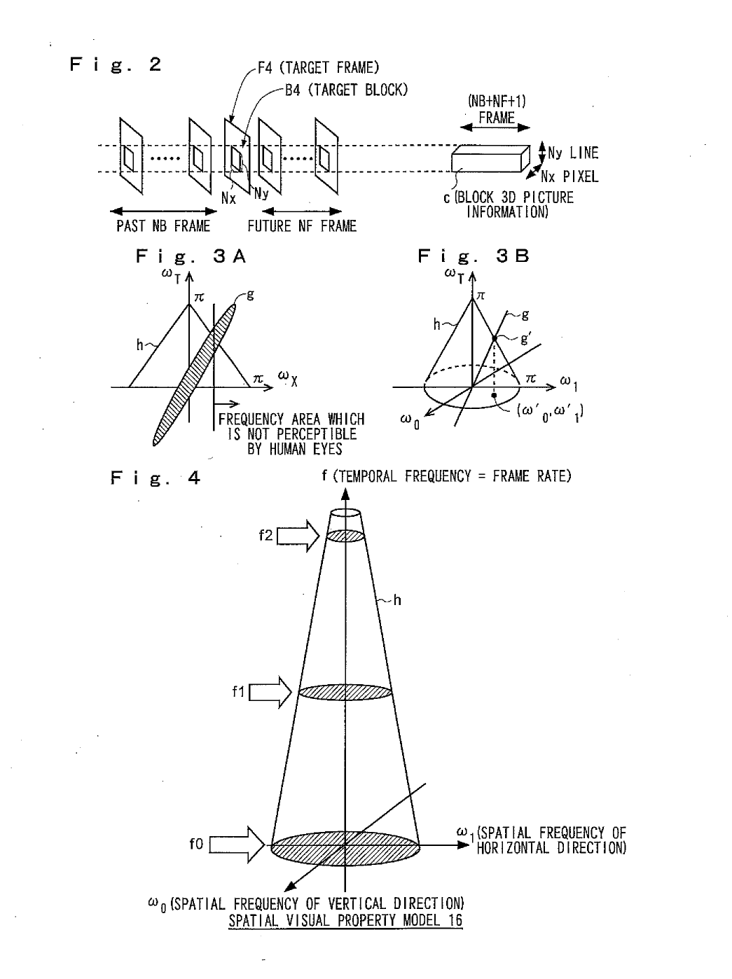

A 3D video signal extracting unit 14 extracts block 3D picture information (c), i.e. a coefficient string, as shown in FIG. 2 from the frame memory 10. In order to reflect the spatio-temporal property of the video, the encode blocks are extracted from the same positions of each frame of (N_{B}+N_{F}+1) frames made of the target frame F4, the past N_{B} frames and the future N_{F} frames. Assuming that the block to be processed is the block B4 within the frame F4 to be processed and its size is N_{X}×N_{y}, the block 3D picture information (c) comprising N_{X}×N_{y}×(N_{B}+N_{F}+1) pixels is extracted. In the following, the block B4 of Nₓ×N_{y} pixels is called macro block.

Then, the 3D FFT 15 is applied to the block 3D picture information (c) to obtain a spatio-temporal frequency property (g). Typically, the result of the 3D FFT 15 shows the property (g) of FIGS. 3A and 3B without considering the folded part, and it can be shown as one straight line through the origin. The folded part surely occurs when the 3D FFT is performed, but its illustration is omitted from FIGS. 3A and 3B. A sign (h) in FIGS. 3A and 3B indicates a visual passband. A spatial frequency component outside the visual passband (h) of the spatia-temporal frequency property (g) is not perceptible by human eyes. The horizontal axis of FIG. 3A indicates the spatial frequency ωₓ and the longitudinal axis indicates the temporal frequency ω_{T}. FIG. 3B three-dimensionally shows the relationship between ωₓ and ω_{T}, where ω₀ indicates the spatial frequency in the vertical direction and ω₁ indicates the spatial frequency in the horizontal direction.

FIG. 4 shows a spatial visual property model 16 (see FIG. 1). Since the visual passband (h) has a human visual pass property that the passband in the spatial frequency direction is wider in a lower temporal frequency f (f0 in FIG. 4) and is narrower as the temporal frequency is higher (f0→f1→f2 in FIG. 4), the spatial visual property model is designed assuming that the model has a cone-like shape as shown in FIG. 4. Since the specific frequency property depends on the resolution of a motion picture to be encoded and the sizes of display systems (monitor, projector), it is suitable that the model is separately designed. The cone of FIG. 4 indicates the visual passband (h) of FIG. 3 and means that the inside of the cone is the passband.

Turning to FIG. 1, an intersection coordinate calculating unit 17 obtains the spatial frequency coordinate (ω₀′, ω₁′) at the intersection between the spatia-temporal frequency property (g) and the visual passband (h). In other words, as shown in FIG. 3B, the spatial frequency coordinate (ω₀′, ω₁′) at the intersection (g′) is obtained. The spatial frequency coordinate (ω₀′, ω₁′) indicates the spatial frequency at the boundary where human eyes cannot perceive.

The input video signal is input into an encoder 21, (for example, a H.264 encoder) via the frame delaying unit 11 to be subjected to intra-encode (intra-prediction) or inter-encode (motion compensation). An encode coefficient (d) obtained by the intra-encode or inter-encode is divided into the sharp and blurred frames in a switching unit 22 which is switched by the sharp/blurred frame mode signal (b). As well known, the intra-encode and the inter-encode comprise a plurality of encode modes, respectively.

When the blurred frame mode, the encode coefficient (d) in each encode mode is transmitted to a coefficient cut processing unit 23, while, when the sharp frame mode, the encode coefficient (d) is transmitted to a next processing unit as usual without any processing by the present invention. The coefficient cut processing unit 23 performs the processing in which the high frequency component of the encode coefficient (or conversion coefficient) of the macro block predictive error signal (called residue signal below) is cut according to the spatial frequency coordinate (ω₀′, ω₁′) found in the intersection coordinate calculating unit 17.

In other words, in the coefficient cut processing unit 23, the high frequency component not perceptible by human eyes is assumed as 0 according to the spatial frequency coordinate (ω₀′, ω₁′), and is removed from the components to be encoded. Consequently, the conversion coefficient having a higher frequency than the spatial frequency coordinate (ω₀′, ω₁′) does not need to be transmitted, thereby reducing the code amount.

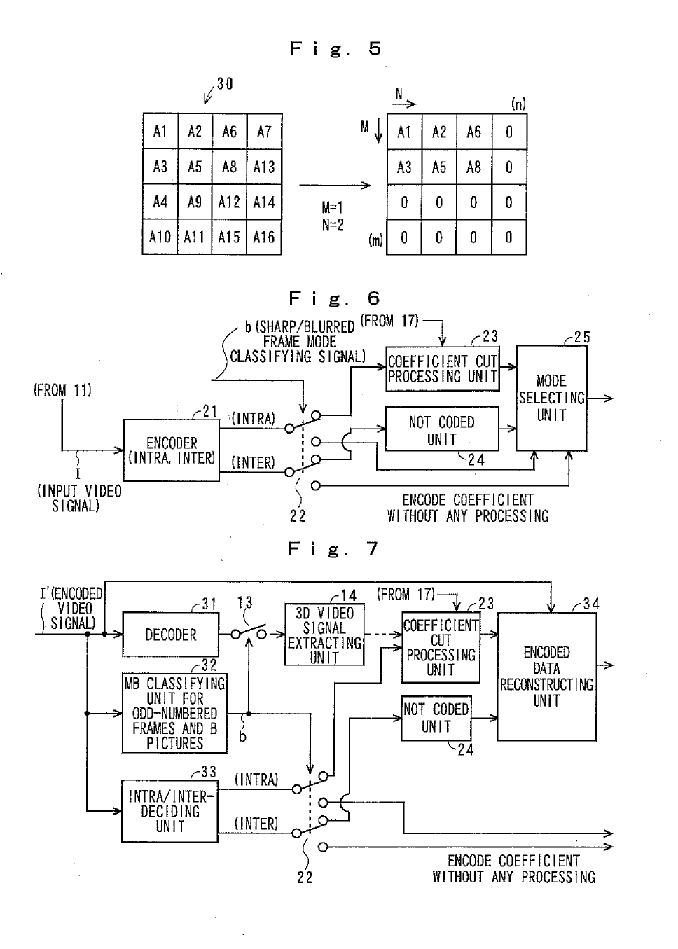

There will be described below with reference to FIG. 5 one specific example of the processing of assuming the conversion coefficient of the macro block residue signal obtained by the intra-encode or inter-encode as 0 according to the spatial frequency coordinate (ω₀′, ω₁′). Assuming that the matrix of the orthogonal conversion coefficient of the residue signal is made in 4×4 size, M and N meeting the following equation (1) are found and the coefficients meeting m≧M and n≧N are assumed as zero for the index (m, n) of the orthogonal conversion coefficient.

(M/4)π≦|ω₀′|<((M+1)/π), (N/4)π≦|ω₁′|<((N+1)/π) (where, M, N=0, 1, 2, 3) (1)

For example, when the matrix in 4×4 size of the residue signal 30 is as shown in FIG. 5 and in the case of M=1 and N=2, a frequency component outside the frequency component at the position (1, 2) may be assumed as 0 as illustrated.

Reference numeral 51 in FIG. 1 indicates an encoder for an applied information of encode control and Reference numeral 52 indicates a muxer, and their functions will be described later.

A second embodiment of the present invention will be described below. As a result of the experiment of the present invention by the present inventors, it is found that even when the encode coefficient (d) or the residue signal is neglected (that is, not coded) for the macro block of the blurred frame subjected to the inter-encode in the encoder 21 of FIG. 1, the picture quality is not largely influenced. Thus, it is found that it is suitable that the coefficient cut by the spatio-temporal frequency property (g) is applied only to the residue signal of the macro block subjected to the intra-encode of the blurred frame.

A third embodiment of the present invention will be described below with reference to FIG. 6. The embodiment is such that a mode selecting unit 25 is added to the second embodiment thereby to select an encode mode having a small code amount. The same reference numerals are denoted to the blocks having the same or similar functions as those of FIG. 1.

The input video signal (I) delayed in the frame delaying unit 11 of FIG. 1, for example, is input into the encoder 21 of FIG. 6. The switching unit 22 is controlled by the sharp/blurred frame mode classifying signal (b), is connected to one illustrated position for the blurred frame, and is connected to the other position for the sharp frame. The mode selecting unit 25 is input an intra-mode encode coefficient having the residue signal subjected to the code amount reduction processing in the coefficient cut processing unit 23 and an inter-mode encode coefficient for which a conversion coefficient value of the residue signal is assumed as 0 in a Not Coded unit 24. The mode selecting unit 25 obtains the code amount of each encode coefficient in the intra-mode and the inter-mode, and selects the encode mode having the smallest code amount. On the other hand, the sharp frame encode coefficient is directly transmitted to the mode selecting unit 25 not via the coefficient cut processing unit 23 and the Not Coded unit 24, and is subjected to the conventional mode selection processing. The mode selecting unit 25 can select the encode mode by a well-known rate distortion optimization processing, for example.

A fourth embodiment when an encoded video signal (I′) is input as the input video signal (I) will be described below with reference to FIG. 7. The same reference numerals are denoted to the blocks having the same or similar functions as those of FIGS. 1 and 6. The processings with numerals 15 to 17 of FIG. 1 are inserted at the dotted line between the 3D video signal extracting unit 14 and the coefficient cut processing unit 23 based on the visual property model in FIG. 7, but an illustration thereof will be omitted for a simplified explanation.

When the encoded video signal (I′) is input, the encoded video signal (I′) is input into a decoder 31, a MB (macro block) classifying unit 32 for odd-numbered frames and B pictures and an intra-/inter-deciding unit 33. The decoder 31 decodes the encoded video signal (I′). The MB classifying unit 32 for odd-numbered frames and B pictures is means for specifying a frame and MB to be processed, i.e. a target frame and MB, and performs the similar processings to the sharp/blurred frame classifying unit 12. Specifically, the MB classifying unit 32 detects the MB which is an odd-numbered frame and a B picture not referred to by other picture from the encoded video signal (I′), and powers on or closes the switching unit 13 on the detection. Thus, the 3D video signal extracting unit 14 extracts a 3D video signal made of the MB which is an odd-numbered frame and a B picture from the video signal decoded in the decoding unit 31. The MB classifying unit 32 may also decide an interval between target frames according to a frame rate of the input signal. Thereafter, the 3D video signal passes the processings with numerals 15 to 17 of FIG. 1, but the processings are the same as those of FIG. 1 and thus an explanation thereof will be omitted.

In the intra-/inter-deciding unit 33, the encoded video signal (I′) is decided which of the intra-mode or the inter-mode is used for the encoding. In the case of the intra-mode, the MB which is an odd-numbered frame and a B picture is transmitted to the coefficient cut processing unit 23 which processes based on the visual property model, and the high frequency component of the residue signal is subjected to the cut processing. In the case of the inter-mode, the MB which is an odd-numbered frame and a B picture is transmitted to the Not Coded unit 24 and the conversion coefficient of the residue signal is set at 0. An encoded data reconstructing unit 34 reconstructs and outputs the encoded data of the encoded video signal (I′) based on the input result.

On the other hand, the intra- or inter-encoded video signal not corresponding to the MB which is an odd-numbered frame and a B picture is output as it is without being subjected to the coefficient cut processing or the processing by the Not Coded unit and without the reconstruction of the encoded data.

The functions of the encoder for the applied information of encode control 51 and the muxer 52 (see FIG. 1) will be described below in detail. The functions also are applicable to the embodiments in FIGS. 6 and 7.

The encoder for the applied information of encode control 51 encodes (1) information on whether the sharp/blurred encode control processing is applied (which will be referred to as encode control processing information below) and (2) information on an applied frame number when the sharp/blurred encode control processing is applied. The encode control processing information and the applied frame number information can be acquired from the sharp/blurred frame mode classifying unit 12. The encode control processing information and the applied frame number information, which are encoded in the encoder for the applied information of encode control 51, are sent to the muxer 52.

The muxer 52 contains the encoded encode control processing information and applied frame number information within a sequence in which image information to which the sharp/blurred encode control processing is applied is sent as a bit stream, and outputs the same. The encoded encode control processing information and applied frame number information also may be separately sent without being contained in the sequence.

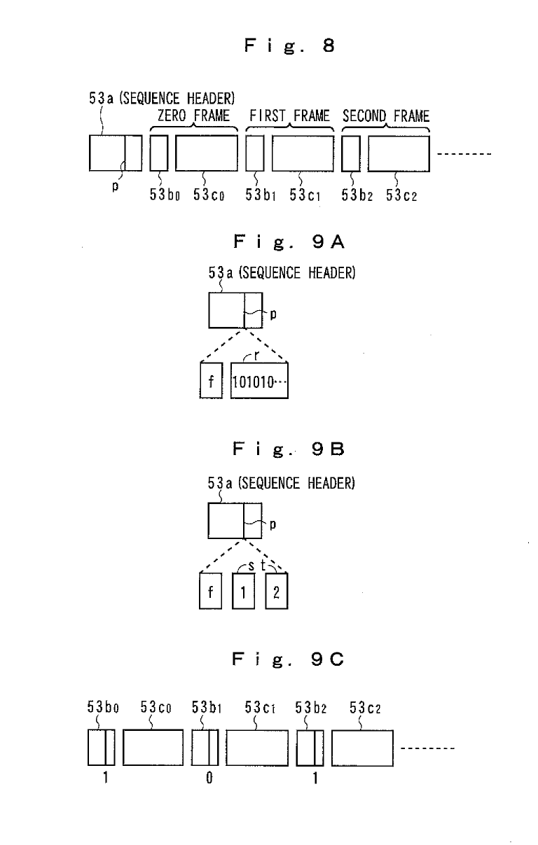

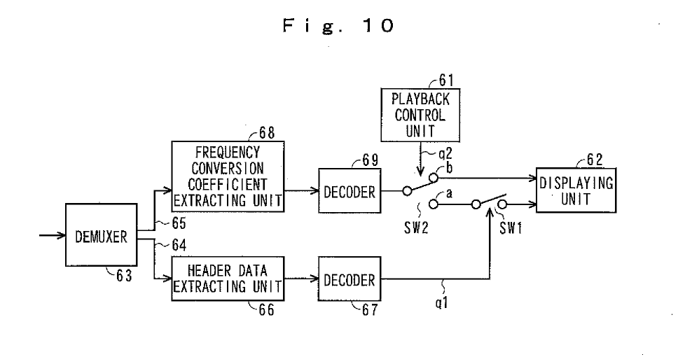

Reference numeral 53 indicates an output signal of the muxer 52. A specific example in which the encoded encode control processing information and applied frame number information are inserted into the sequence will be described with reference to FIG. 8. FIG. 8 is a conceptual diagram of the sequence format, where the sequence is configured of a sequence header 53a, a frame header 53bn, and image data made of image data 53 cn (n=0, 1, 2, 3, . . . ). Herein, n indicates a frame number of an image signal. The encoded encode control processing information and applied frame number information can be inserted at position (p) of the sequence header 53a or in the frame header 53bn. The exemplary insertion will be described with reference to FIGS. 9A to 9C.

In FIG. 9A, the flag (f) of the encode control processing information, that is, the flag (f) indicating whether the sharp/blurred processing is applied, and a number string (r) (made of 0 or 1) indicating a sharp/blurred processed frame are contained at position (p) of the sequence header 53a. In the number string (r), “1” indicates a sharp frame and “0” indicates a blurred frame. Reversely, “0” may indicate the sharp frame and “1” may indicate the blurred frame.

In FIG. 9B, the flag (f) of the encode control processing information, that is, the flag (f) indicating whether the sharp/blurred processing is applied, the first blurred applied frame number (s), and applied frame interval information (t) are contained at position (p) of the sequence header 53a. In the illustrated example, since s=1 and t=2 are assumed, the first blurred applied frame is the first frame, and the blurred frame is subsequently applied per frame.

In FIG. 9C, the flag (f) indicating whether the corresponding frame is a blurred frame or a sharp frame is inserted in the frame header 53bn. In the illustrated example, there is shown that the 0-th frame is a sharp frame (1), the first frame is a blurred frame (O), the second frame is a sharp frame (1), . . . .

One embodiment of a reproducing apparatus will be described below with reference to FIG. 10. FIG. 10 is a schematic block diagram of the reproducing apparatus, where the reproducing apparatus has a playback control unit 61, a displaying unit 62 and a demuxer 63 for separating multiplexed information.

The demuxer 63 is input multiplexed image information such as the output signal 53. The demuxer 63 separates header information 64 and image data 65 from the multiplexed image information. A header data extracting unit 66 extracts the flag (f) of the encode control processing information and the applied frame number information at position (p) from the sequence header 53a, and sends them to a decoder 67. The decoder 67 decodes the flag (f) and the applied frame number information. An applied frame number signal (q1) acquired by the decoding is sent to a first switching unit (SW1). On the other hand, a frequency conversion coefficient of the image data 65 is extracted by a frequency conversion coefficient extracting unit 68 and is decoded by a decoder 69.

Instruction signals (q2) such as normal playback, slow motion playback and pause are output from a playback control unit 61 and sent to a second switching unit SW2. The second switching unit SW2 selects contact (a) when the instruction signal (q2) is for slow motion playback and pause, and selects contact (b) in other cases. The first switching unit SW1 is turned off (open) when the applied frame number signal (q1) is for a blurred frame, and turned on (close) when the applied frame number signal q1 is for a sharp frame.

Thereby, when the second switching unit SW2 is connected to contact (b) during normal playback, the decoded sharp and blurred frames are displayed on the displaying unit 62. However, during slow motion playback or pause, since the second switching unit SW2 is connected to contact (a) and the first switching unit SW1 is turned off (open) or on (close) by the applied frame number signal (q1) as described above, the blurred frame is skipped and is not displayed on the displaying unit 62.

The first and second switching units SW1 and SW2 are merely exemplary for simplified explanation, and can be realized by a circuit, such as a logic circuit having a similar function to the switching units.

According to the embodiments, the blurred frames are not displayed on the displaying unit 62 during slow motion playback or pause, thereby preventing deteriorated images from being displayed.

The present invention has been described above using the preferred embodiments, but the present invention is not limited to the embodiments, and it is clear that various modifications may be made within the scope of the present invention.

What is claimed is:

1. A code amount reducing apparatus in an apparatus for performing frequency conversion such as orthogonal conversion on a predictive error signal obtained by using a correlation between video signals in the temporal or spatial direction, and then encoding said predictive error signal, comprising:
a target frame specifying unit for specifying a frame to be processed;
a coefficient string acquiring unit for acquiring a coefficient string by collectively frequency-converting, for a target frame specified in said target frame specifying unit, pixel values at predetermined area or predetermined macro block of said target frame and pixel values at the same area or macro block in the frames before and after said target frame;
a unit for finding a non-perceptible coefficient based on a spatio-temporal visual property model for said coefficient string; and
a unit for setting said non-perceptible high frequency coefficient at 0 for a frequency conversion coefficient of orthogonal conversion of said predictive error signal.

2. The code amount reducing apparatus according to claim 1, wherein when frames before and after said target frame have already been encoded, said coefficient string acquiring unit utilizes a decoded picture of said encoded frames.

3. The code amount reducing apparatus according to claim 1, wherein when said encode is in the intra-mode, said non-perceptible high frequency coefficient is set at 0 for said frequency conversion coefficient of orthogonal conversion of said predictive error signal, and
when said encode is in the inter-mode, all said frequency conversion coefficients of orthogonal conversion of said predictive error signal are set at 0.

4. The code amount reducing apparatus according to claim 2, wherein when said encode is in the intra-mode, said non-perceptible high frequency coefficient is set at 0 for said frequency conversion coefficient of orthogonal conversion of said predictive error signal, and
when said encode is in the inter-mode, all said frequency conversion coefficients of orthogonal conversion of said predictive error signal are set at 0.

5. The code amount reducing apparatus according to claim 3, further comprising an encode mode selecting unit,
wherein said encode mode selecting unit selects an encode mode having a smaller code amount from among the intra-mode in which said non-perceptible high frequency coefficient is set at for said frequency conversion coefficient of orthogonal conversion of said predictive error signal and the inter-mode in which all said frequency conversion coefficients of orthogonal conversion of said predictive error signal are set at 0.

6. The code amount reducing apparatus according to claim 4, further comprising an encode mode selecting unit,
wherein said encode mode selecting unit selects an encode mode having a smaller code amount from among the intra-mode in which said non-perceptible high frequency coefficient is set at for said frequency conversion coefficient of orthogonal conversion of said predictive error signal and the inter-mode in which all said frequency conversion coefficients of orthogonal conversion of said predictive error signal are set at 0.

7. The code amount reducing apparatus according to claim 1, wherein said target frame specifying unit specifies a frame or macro block not to be referred to during the encoding.

8. The code amount reducing apparatus according to claim 7, wherein said target frame specifying unit decides an interval between target frames according to a frame rate of an input signal.

9. An encoder including the code amount reducing apparatus according to claim 1, comprising:
a unit for encoding encode control processing information and applied frame number information acquired from said target frame specifying unit,
wherein said encode control processing information and said applied frame number information encoded by said encoding unit are inserted into a bit stream containing said frequency conversion coefficient whose code amount is reduced by said code amount reducing apparatus, and are output.

10. The encoder according to claim 9, wherein said encoded encode control processing information and applied frame number information are inserted into a sequence header of a sequence format of said output or a frame header.

11. An encoder for performing frequency conversion such as orthogonal conversion on a predictive error signal obtained by using a correlation between video signals in the temporal or spatial direction, and then encoding said predictive error signal, comprising:
a decoder for decoding an encoded video signal;
a target frame specifying unit for specifying a frame to be processed;
a unit for acquiring a coefficient string by collectively frequency-converting, for a target frame decoded in said decoding unit and specified in said target frame specifying unit, pixel values at predetermined area or predetermined macro block of said target frame and pixel values at the same area or macro block in the frames before and after said target frame;
a unit for finding a non-perceptible coefficient based on a spatia-temporal visual property model for said coefficient string;
a unit for setting said non-perceptible high frequency coefficient at 0 for a frequency conversion coefficient of orthogonal conversion of said predictive error signal; and
a unit for reconstructing encoded data of said encoded video signal based on the result that said non-perceptible high frequency coefficient is set at 0.

12. The encoder according to claim 11, wherein when the encode mode of said encoded video signal is the intra-mode, said non-perceptible high frequency coefficient is set at 0 for said frequency conversion coefficient of orthogonal conversion of said predictive error signal, and when the encode mode is the inter-mode, all said frequency conversion coefficients of orthogonal conversion of said predictive error signal are set at 0.

13. The encoder according to claim 11, wherein said target frame specifying unit specifies a frame or macro block not to be referred to during the encoding.

14. The encoder according to claim 13, wherein said target frame specifying unit decides an interval between target frames according to a frame rate of an input signal.

15. The encoder according to claim 11, comprising:
a unit for encoding encode control processing information and applied frame number information acquired from said target frame specifying unit,
wherein said encode control processing information and said applied frame number information encoded by said encoding unit are inserted into a bit stream reconstructed by a unit for reconstructing said encoded data, and are output.

16. The encoder according to claim 15, wherein said encoded encode control processing information and applied frame number information are inserted into a sequence header of a sequence format of said output or a frame header.

17. A decoder for decoding a video signal encoded by an encoder, comprising:
a unit for separating a frequency conversion coefficient of a video signal, said encode control processing information and said applied frame number information from said bit stream;
a unit for decoding said separated frequency conversion coefficient;
a displaying unit for displaying a video signal acquired by said decoding;
a unit for decoding said separated encode control processing information and applied frame number information; and
a playback control unit for outputting a playback control signal,
wherein when a control signal for slow motion playback or pause is output from said playback control unit, a processed frame specified by said target frame specifying unit from a video signal acquired by said decoding is skipped, and is not displayed on the displaying unit.
